(19) United States
(12) Patent Application Publication
(10) Pub. No.: US 2025/0345240 A1
(43) Pub. Date: Nov. 13, 2025

(54) Rotary Pillbox

(71) Applicant: WIlliam Clay Moseley, Seattle, WA (US)

(72) Inventor: WIlliam Clay Moseley, Seattle, WA (US)

(21) Appl. No.: 18/658,903

(22) Filed: May 8, 2024

(51) Int. Cl. A61J 1/03

(52) U.S. Cl. CPC A61J 1/03

(57) ABSTRACT

A pillbox whose body takes the form of a thin cylinder with a shallow body in the middle separated into separate “pockets” by walls erected through the diameter of the body to form two or more equal segments of the body (ambiguous to pizza slices). A circular top and bottom then cover the body in order to have the cylinder sealed off at the top and bottom whilst still being hollow on the inside. The cylinder's ring side lack walls, thus making the segments of the body into cavities of equal sizes whose openings encompass the ring side of the cylinder. A sleeve does, however, wrap snugly around the ring side of the cylinder, possessing a square opening roughly the same size as one of the cavities of the cylinder. The sleeve is then held in place by two protruding lips (one at the top and one at the bottom) of the cylinder due to the top and bottom sides of the cylinder overhanging the ring side itself. Due to this, the ring sleeve cannot move up or down the depth of the cylinder and is thus stuck in place, however, can still rotate around the ring side of the cylinder.

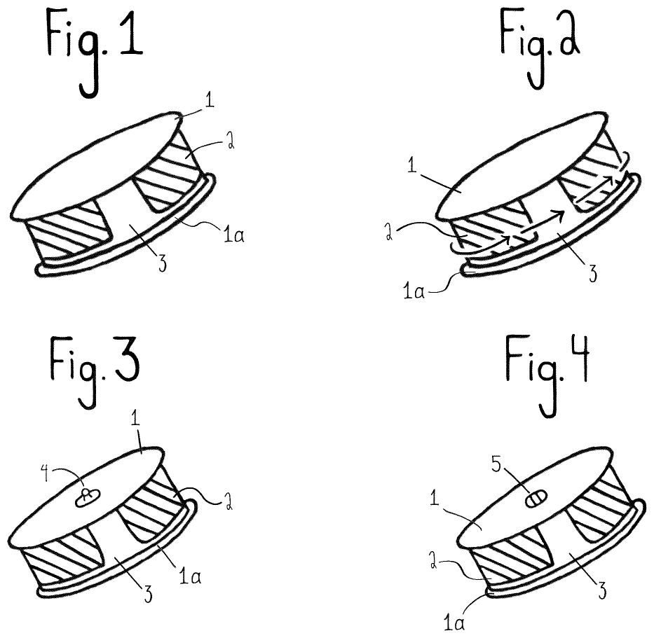

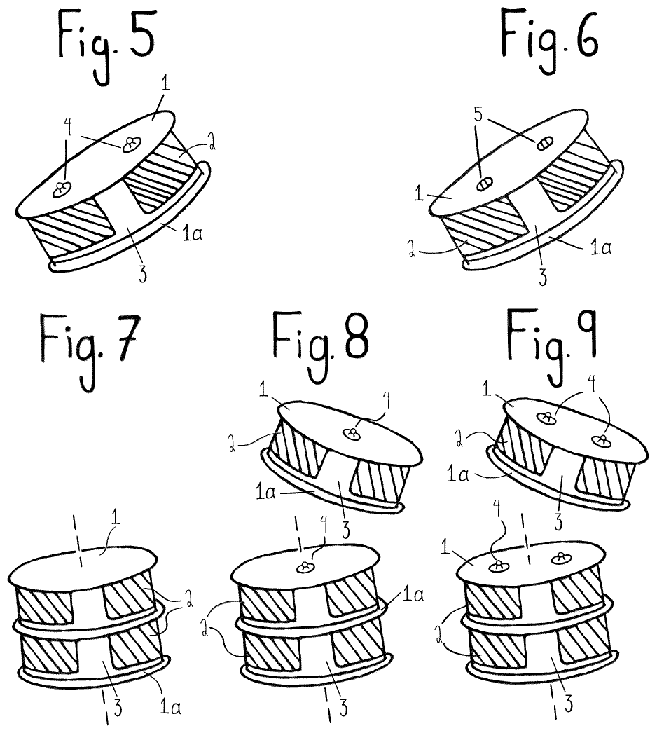

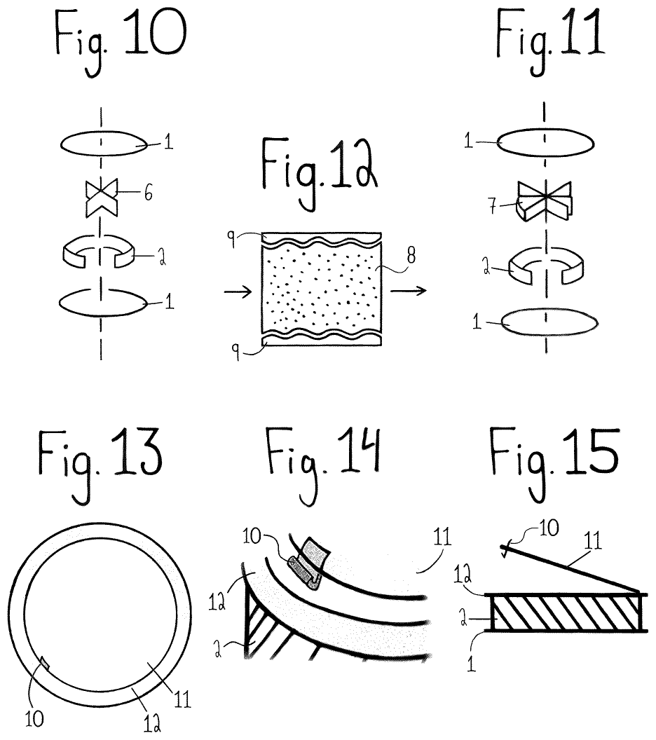

Referring now to FIG. 1 of the drawings, the pillbox is shown as a side view, with 1 being the top of the box and is stationary and la is the base of the pillbox that is stationary. 2, in hatched lines, shows a sleeve that rotates around the circumference of the box; 3 is a gap in the sleeve that opens to a one of several internal compartments as the sleeve is rotated, and the sleeve is the same height of a single compartment to allow for full dispensing of the contents of the compartment when tilted to the side.

Referring now to FIG. 2 of the drawings, the pillbox is shown as a side view, with the arrows showing directionality of moving the sleeve (2) between the top of the pillbox (1) and the base of the pillbox (la). The sleeve can move two ways, to the right as shown by arrow (counterclockwise) and to the left (clockwise).

Referring now to FIG. 3 of the drawings, 4 shows one male fitting end on the top (1). The base of the pillbox (la) can have a female fitting that is not shown, and can be used to enable stacking of the boxes by snapping together the male and female fittings. The rotational sleeve is shown in 2 with the compartment opening shown as 3.

Referring now to FIG. 4 of the drawings, 5 shows one female fitting end on the top of the box (1). The base of the pillbox (la) can have a male fitting that is not shown, and can be used to enable stacking of the boxes by snapping together the male and female fittings. The rotational sleeve is shown as 2 with the compartment opening shown as 3.

Referring now to FIG. 5 of the drawings, 4 shows two male fittings on the top and la is the base of the pillbox that is stationary. Two male fittings on one circular pillbox can be snapped together with another circular pillbox having two female fittings; having two snapped together fittings can add more stability to the stack of pillboxes if desired, to help them stay in place. 2, in hatched lines, shows a sleeve that rotates around the circumference of the box; 3 is a gap in the sleeve that opens to a one of several internal compartments as the sleeve is rotated and the sleeve is the same height of a single compartment to allow for full dispensing of the contents of the compartment when tilted to the side.

Referring now to FIG. 6. of the drawings, 5 shows two female fittings on the top and la is the base of the pillbox that is stationary. Two male fittings on one circular pillbox can be snapped to two male fittings that are on another circular pillbox; having two snapped together fittings can add more stability to the stack of pillboxes if desired, to help them stay in place. 2 in hatched lines shows a sleeve that rotates around the circumference of the box; 3 is a gap in the sleeve that opens to a one of several internal compartments as the sleeve is rotated, and the sleeve is the same height of a single compartment to allow for full dispensing of the contents of the compartment when tilted to the side.

Referring now to FIG. 7 of the drawings, shows an option for the stacking of two (or more, but not shown) pillboxes on top of each other, without male or female fittings, and thus do not snap together. Adhesive in the form of glue or tape among other options, for example could be used to keep them aligned on top of each other and stacked together. Additionally, the bottom side of the top pillbox could also function as the top side of the pillbox directly beneath it. The sleeve (2) and the bottom (la) with 3 as a gap in the sleeve that opens to a single compartment and is the same width of a single compartment and is present on all present pillboxes.

Referring now to FIG. 8 of the drawings, shows an option for the stacking of three (or more, but not shown) pillboxes in which one male fitting and one female fitting join to connect the pillboxes. There is 4, the male fitting of the receiving top pillbox and is attached to the female fitting (not shown, but described in FIG. 4) in the base (la). Two boxes are connected together with the third box able to be placed on top with la and 4 coming together combining the single snap. The top most pillbox's top side and bottom most pillbox's bottom side on a given pillbox stack can come together without a snap as well.

Referring now to FIG. 9 of the drawings, shows an option for the stacking of three (or more, but not shown) pillboxes in which two male fittings and two female fittings join to connect the pillboxes. The arrangement of fittings and number of fittings can be more or less than two, but two is described here for illustration purposes. There is 4, the male fitting of the receiving top pillbox, and is attached to the female fitting (not shown, but described in FIG. 4) in the base (la). Two male fittings on one circular pillbox can be snapped to two female fittings on another circular pillbox to add more stability to the stack of pillboxes if desired to help them stay in place. Two boxes are connected together with the third pillbox able to be placed on top with la and 4 coming together to snap the fittings. The top most pillbox's top side and bottom most pillbox's bottom side on a given pillbox stack can also be used wherein the fittings snap together between the pillboxes.

Referring now to FIG. 10 of the drawings, shows a pillbox separated out by individual parts, unconnected to one another, with an axis running through the middle of each part portraying where the center of said part is. 1 portrays the top side of the pillbox and 1 portrays the bottom side of the pillbox. These two parts as being called the “top” or “bottom” are arbitrary to one another with both 1 and 1 technically functioning as both the “top” and the “bottom” at the same type due to their identical shape and distance from the invisible line of symmetry that runs parallel to the top, 1 and bottom, 1 and horizontally through the middle of the middle of the pillbox. 6 portrays the cavity walls of the pillbox to create the cavity which the pills are subsequently put between. While 6 portrays four separate compartments in FIG. 10, however the number of individual compartments can be more or less than this. 2 shows the crescent shaped sleeve that is able to rotate freely horizontally, however is blocked in vertically by the overhanging lips of 1 (top) and 1 (bottom) in order to cover or uncover the series of internal compartments. Unlike the physical bond 1 (top) and 1 (bottom) have to 6, 2 hugs the top and bottom (1) creates friction to keep it from moving without being induced to by the user, however is not physically bonded to them as to allow for movement when the user wishes to access a different compartment.

Referring now to FIG. 11 of the drawings, shows a pillbox separated out by individual parts, unconnected to one another, with an axis running through the middle of each part portraying where the center of said part is. 1 portrays the top side of the pillbox and 1 portrays the bottom side. These two parts as being called the “top” or “bottom” are arbitrary to one another with both are technically functioning as both the “top” and the “bottom” at the same type due to their identical shape and distance from the invisible line of symmetry that runs parallel to top and bottom and horizontally through the middle of the pillbox. 7 portrays the cavities of the pillbox and the walls that are in the middle of 1 (top) and 1 (bottom), which the pills are subsequently put between. 7 portrays six separate compartments, however the number of individual compartments can be more or less than this. However, 7 also has one of its compartments filled in as to allow for a compartment that the opening of the sleeve can be over, in a situation in which all other compartments are full of materials. In so having a filled-in compartment, the contents of each compartment will not spill out so long as the opening of the sleeve has a filled in compartment to stop over when all the other compartments are full and would spill out if the sleeve opening was over them. The number of filled in compartments can also vary depending upon the need of the user. 2 shows the crescent shaped sleeve that is able to rotate freely horizontally, however is blocked in vertically by the overhanging lips of 1 in order to cover or uncover the series of internal compartments to the user. Unlike the physical bond that 1 (top) and 1 (bottom) have to 7, 2 hugs up to 1 (top) and 1 (bottom) creating friction to keep it from moving without being induced to by the user, however is not physically bonded to them as to allow for movement when the user wishes to access a different compartment.

Referring now to FIG. 12 of the drawings, shows a blow-up view of the sleeve, 8 with optional grooves as part of the top and bottom lips of 1 that click into place (9) as the sleeve is being rotated.

Referring now to FIG. 13 of the drawings, shows a top view of the pillbox with an optional lid and latch attached to the top of the container. 11 portrays the optional lid of the container in which it is able to open and close and show all the cavities of the container contingent upon the movement of 10: the latch. 10 is able to take on a multiple of different latch types, however, is portrayed in FIG. 13, FIG. 14, and FIG. 15 as a simple mechanism in which the pulling upon it's lip towards the nearest end of the container to it will, by extension, induce the latch that is normally connected to a hinge underneath 12 to become unstrained by tension and allow the lid to be opened. 12 portrays the top of the pillbox that is not part of the optional lid, however is analogous to 1 in the other figures. It is able to keep the lid in place on the pillbox as well as the sleeve (2) in place as well.

Referring now to FIG. 14 of the drawings, shows a close-up, top angled side view of the pillbox with the optional lid (11) and latch (10) attached to the top of the container that also holds the rotary sleeve (2) in place. The rest of the image is cut off as it would be too large to fit on a page and already well diagramed in FIG. 15. The unlabeled space that rests between 10 and 11 is the undrawn insides of the pillbox that is shown in FIG. 10 and FIG. 11. The figure shows the pillbox in a state of being slightly open.

Referring now to FIG. 15 of the drawings, shows a view of the pillbox with the optional lid (11) and latch (10) from a side viewpoint exactly parallel to the pillbox as a whole. The latch (10) is attached to the lid (11) which is positioned upon the top of the pillbox (12) so it may move up and down with the movement allowed by a butt hinge (or functional equivalent) on the opposite side of the lid. 2 portrays a side view of the rotary sleeve that is bookended by 1 and 12 with the opening of this sleeve not portrayed in this image (as it is in FIGS. 1-11). 1 portrays the lidless and latchless bottom of the container that both keeps the contents of the pillbox secure and keeps the sleeve (2) in place. The figure shows the pillbox in a state of being slightly open.

1. A cylindrical pillbox wherein;
a cylindrical body lacking side walls is divided with one or more separating walls going through the center of the cylinder;
the separating walls are sealed off on the top and bottom, making the body hollow on the outside, and thus, the hollow body is fully composed of a series of adjacent, separated cavities of roughly equal size whose openings rotate around (and form the side of) the ring side of the cylindrical body;
a sleeve ring wrapping around the entirety of the cylindrical body, wherein there is an opening to the sleeve of roughly the same size as one of the openings of the cylindrical body's composed cavities;
the sleeve is rotated relative to the fixed top, bottom, and divider walls in which the sleeve ring must be tight enough to not loosely move around the body unless it is acted upon by an outside force, however not tight enough so the sleeve cannot rotate its opening around the cavities of the cylindrical body, in this way the sleeve opening allows for pouring of contents by tipping the pillbox's sleeve ring at a downward facing angle;
both the top and the bottom cylindrical body coverings extend slightly farther out than the sleeve ring, thereby the top and bottom coverings form a lip or overhang over the sleeve ring and the edges of the walls so as to inhibit the ring sleeve from sliding up and down the cylinder and keeping it on a preset path for it to rotate around the cylindrical body horizontally.

2. The cylindrical pillbox according to claim 1, wherein parts or all of said pillbox may be made up of a transparent material.

3. The cylindrical pillbox according to claim 1, wherein one or more of the cavities of the body's separating walls may be filled in so as to allow a section of the cylinder for the sleeve ring to rest at, so when there are things being held within the cavities of the pillbox, the contents do not spill out through the opening of the sleeve ring.

4. The cylindrical pillbox according to claim 1, wherein:
the pillbox may have a design that pulls upon the sleeve ring in order to further keep the sleeve from moving and keeping it stopped at a particular cavity or to act as an alternative to having a tight sleeve;
the method that would allow the sleeve to be harder to move at the cavities may be done by a plurality of ways, including but not limited to, adding positioning grooves to one or both lips facing toward the ringside.

5. The cylindrical pillbox according to claim 1, wherein the top side of the container that covers the body is an openable covering using a mechanism as to lock it in place (such as a latch or a mechanism that works for an equivalent purpose).

6. The cylindrical pillbox according to claim 5, wherein:
the bottom covering of the box that covers the body may be an openable covering also, and if so, there would be a separator running between the cross section across the ring side of the cylinder in order to give the cylinder two equal faces;
the separator would have a lip, similar to that of the top and bottom coverings;
the lip would then separate two different ring sleeves that run separately;
the depth of each size may be enlarged in order for the contents of each well in the body has sufficient room for its contents, as it had in claim 5.

7. The cylindrical pillbox according to claim 1, wherein:
said pillbox has multiple, repeated layers of itself stacked vertically as described in claim 1 to add additional cavities for additional contents;
the middle “lips” of the cylindrical pillbox may also be stacked upon one another or may simply be merged into one “lip” each, of which functions dually as a bottom covering for the layer above it and the top covering for the layer below it.

8. The cylindrical pillbox according to claim 1, wherein said pillbox has a functional mechanism (such as a latch, snap fastener [with the protrusion of the snap fastener being on the top covering of a layer and the cavity of the snap fastener on the bottom covering], etc.) to allow it to be linked vertically with identical pillboxes for the addition or subtraction of layers to the pillbox.
